(19) United States
(12) Patent Application Publication
(10) Pub. No.: US 2022/0118729 A1
(43) Pub. Date: Apr. 21, 2022

(54) Punch Head, Punch, Shaping Apparatus, Container Making Machine, Shaping Method, and Bottom Blank and Container Formed Therefrom

(71) Applicant: WestRock MWV, LLC, Atlanta, GA (US)

(72) Inventors: Brian K. KNAPP, West Point, VA (US); Timothy R. MCNEAL, Richmond, VA (US); James M. TAYLOR, Highland Springs, VA (US); Jiebin PANG, Glen Allen, VA (US); Joel C. PANEK, Moseley, VA (US); Casey P. GREY, Richmond, VA (US); Babak MIRZAEI, Richmond, VA (US)

(21) Appl. No.: 17/505,481

(22) Filed: Oct. 19, 2021

Related U.S. Application Data
(60) Provisional application No. 63/093,354, filed on Oct. 19, 2020.

(51) Int. Cl. B31B 50/59

(52) U.S. Cl. CPC B31B 50/592

(57) ABSTRACT

A cylindrical punch head, for shaping a paperboard bottom blank to shape a peripheral skirt portion about a periphery of the paperboard bottom blank, includes a punch face extending in a radial direction about an axis of the punch head, a punch sidewall extending in the axial direction of the punch head about a periphery of the punch face, and a border of the punch face and the punch sidewall. The border may be stepped or beveled. The border may include a plurality of edges extending around the punch face.

### PRIORITY

This application claims priority from U.S. Ser. No. 63/093,354 filed on Oct. 19, 2020, the entire contents of which are incorporated herein by reference.

### FIELD

The present application relates to the field of paperboard containers, in particular, shaped paperboard bottom blanks, containers formed therefrom, and punches, shaping apparatus, and shaping methods for shaping paperboard bottom blanks and containers formed therefrom.

### BACKGROUND

Paperboard is used in various packaging applications. For example, paperboard is used to package beverage containers, frozen foods, cereals and a wide variety of other food and non-food consumer goods. Paperboard is often required to have enhanced barrier properties, including oil, grease, water, and/or moisture vapor barrier properties. Additionally, many paperboard packages, for example, paperboard cups for food or drink services, also require the paperboard be heat-sealable, making it possible to form cups on a cup making machine. Conventional polyethylene extrusion coated paperboard dominates in such applications by providing both barrier and heat-seal properties. However, conventional polyethylene extrusion coated paperboard has difficulties in repulping and are not easily recyclable, causing environmental concerns.

Repulpable aqueous coatings are one of the promising solutions to address this need. However, the use of repulpable aqueous coated paperboard has presented challenges with regards to cracking of the coatings, when shaping a coated paperboard bottom blank for a paperboard container, resulting in staining and/or leaking

Accordingly, those skilled in the art continue with research and development efforts in the field of paperboard containers.

### SUMMARY

In a first embodiment, a cylindrical punch head, for shaping a paperboard bottom blank to shape a peripheral skirt portion about a periphery of the paperboard bottom blank, includes a punch face extending in a radial direction about an axis of the punch head, a punch sidewall extending in the axial direction of the punch head about a periphery of the punch face, and a stepped border of the punch face and the punch sidewall.

A container bottom shaping apparatus, for shaping a paperboard bottom blank to shape a peripheral skirt portion about a periphery of the paperboard bottom blank, includes the cylindrical punch head of the first embodiment and a die having a cylindrical recess for receiving the cylindrical punch head.

A paperboard container making machine includes the container bottom shaping apparatus including the cylindrical punch head of the first embodiment, a mandrel for holding paperboard bottom blank shaped by the container bottom shaping apparatus, a sidewall station for receiving a sidewall blank and rotating the sidewall blank about the mandrel, and a heater for heating and sealing the sidewall blank to the bottom blank.

A method for shaping a paperboard bottom blank includes providing a paperboard bottom blank having a caliper thickness t and shaping the paperboard bottom blank using the cylindrical punch head of the first embodiment, thereby shaping paperboard bottom blank to form a bottom wall and a peripheral skirt having a skirt height L about a periphery of the bottom wall of the paperboard bottom blank.

There is a paperboard bottom blank shaped by the method using the cylindrical punch head of the first embodiment.

A paperboard container includes the paperboard bottom blank shaped by the method using the cylindrical punch head of the first embodiment and a sidewall sealed to the shaped paperboard bottom blank.

In a second embodiment, a cylindrical punch head, for shaping a paperboard bottom blank to shape a peripheral skirt portion about a periphery of the paperboard bottom blank, includes a punch face extending in a radial direction about an axis of the punch head, a punch sidewall extending in the axial direction of the punch head about a periphery of the punch face, and a beveled border of the punch face and the punch sidewall.

A container bottom shaping apparatus, for shaping a paperboard bottom blank to shape a peripheral skirt portion about a periphery of the paperboard bottom blank, includes the cylindrical punch head of the second embodiment and a die having a cylindrical recess for receiving the cylindrical punch head.

A paperboard container making machine includes the container bottom shaping apparatus including the cylindrical punch head of the second embodiment, a mandrel for holding paperboard bottom blank shaped by the container bottom shaping apparatus, a sidewall station for receiving a sidewall blank and rotating the sidewall blank about the mandrel, and a heater for heating and sealing the sidewall blank to the bottom blank.

A method for shaping a paperboard bottom blank includes providing a paperboard bottom blank having a caliper thickness t and shaping the paperboard bottom blank using the cylindrical punch head of the second embodiment, thereby shaping paperboard bottom blank to form a bottom wall and a peripheral skirt having a skirt height L about a periphery of the bottom wall of the paperboard bottom blank.

There is a paperboard bottom blank shaped by the method using the cylindrical punch head of the second embodiment.

A paperboard container includes the paperboard bottom blank shaped by the method using the cylindrical punch head of the second embodiment and a sidewall sealed to the shaped paperboard bottom blank.

In a third embodiment, a cylindrical punch head, for shaping a paperboard bottom blank to shape a peripheral skirt portion about a periphery of the paperboard bottom blank, includes a punch face extending in a radial direction about an axis of the punch head, a punch sidewall extending in the axial direction of the punch head about a periphery of the punch face, and a border of the punch face and the punch sidewall, the border comprising a plurality of edges extending around the punch face.

A container bottom shaping apparatus, for shaping a paperboard bottom blank to shape a peripheral skirt portion about a periphery of the paperboard bottom blank, includes the cylindrical punch head of the third embodiment and a die having a cylindrical recess for receiving the cylindrical punch head.

A paperboard container making machine includes the container bottom shaping apparatus including the cylindrical punch head of the third embodiment, a mandrel for holding paperboard bottom blank shaped by the container bottom shaping apparatus, a sidewall station for receiving a sidewall blank and rotating the sidewall blank about the mandrel, and a heater for heating and sealing the sidewall blank to the bottom blank.

A method for shaping a paperboard bottom blank includes providing a paperboard bottom blank having a caliper thickness t and shaping the paperboard bottom blank using the cylindrical punch head of the third embodiment, thereby shaping paperboard bottom blank to form a bottom wall and a peripheral skirt having a skirt height L about a periphery of the bottom wall of the paperboard bottom blank.

There is a paperboard bottom blank shaped by the method using the cylindrical punch head of the third embodiment.

A paperboard container includes the paperboard bottom blank shaped by the method using the cylindrical punch head of the third embodiment and a sidewall sealed to the shaped paperboard bottom blank.

Other embodiments of the disclosed punch head, container bottom shaping apparatus, paperboard container making machine, method for shaping a paperboard bottom blank, shaped paperboard bottom blank, and paperboard container will become apparent from the following detailed description, the accompanying drawings and the appended claims.

### BRIEF DESCRIPTION OF THE DRAWINGS

FIG. 1 is an image of a paperboard bottom blank showing severe wrinkling.

FIG. 2 is a side view of a control punch according to a comparative example.

FIG. 3 is a perspective view of the punch of FIG. 2.

FIG. 4 is a side view of a punch according to a first example of the present description.

FIG. 5 is a perspective view of the punch of FIG. 4.

FIG. 6 is a side view of a punch according to a second example of the present description.

FIG. 7 is a perspective view of the punch of FIG. 6.

FIG. 8 is a side view of a punch according to a third example of the present description.

FIG. 9 is a perspective view of the punch of FIG. 8.

FIG. 10 is a perspective view showing a variation of an exemplary punch having a center recess according to the present description.

FIG. 11 is a perspective view showing a variation of an exemplary punch formed from a combination of materials according to the present description.

FIG. 12 is a perspective view of an exemplary paperboard bottom blank capable of use with the punch of the present description.

FIG. 13 is a sectional side view of the exemplary paperboard bottom blank of FIG. 12.

FIGS. 14A, 14B and 14C are schematic views of an exemplary container bottom shaping apparatus for shaping the paperboard bottom blank of FIGS. 12 and 13.

FIG. 15 is a photograph of a paperboard bottom blank after shaping with a control punch according to the comparative example of FIGS. 2 and 3.

FIG. 16 is a photograph of a paperboard bottom blank after shaping with a punch according to the second example of FIGS. 6 and 7.

FIG. 17 is a schematic view of an exemplary paperboard container making machine that may include a punch of the of the present description.

FIG. 18 is a sectional schematic view of a representation of a paperboard container that may be made using a punch of the of the present description.

FIG. 19 is a photograph of a paperboard container formed from a paperboard bottom blank shaped using a control punch according to the comparative example of FIGS. 2 and 3.

FIG. 20 is a photograph of a paperboard container formed from a paperboard bottom blank shaped using a punch according to the second example of FIGS. 6 and 7.

### DETAILED DESCRIPTION

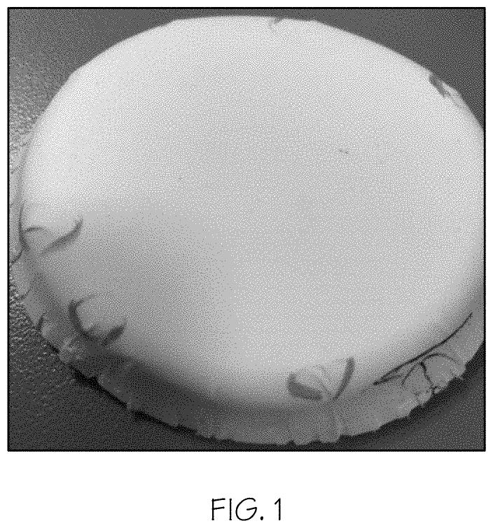

FIG. 1 shows an uncontrolled severe wrinkling of a paperboard bottom blank. As shown by the markings in FIG. 1, numerous wrinkles propagate beyond peripheral skirt of the shaped paperboard bottom blank to the bottom wall of the paperboard bottom blank. Conventional polymer extrusion barrier coatings, such as polyethylene, can survive the conventional shaping process without cracking. However, these wrinkles disrupt the film formed by other barrier coatings and provide channels and weak points for liquid to penetrate, causing staining or leaking upon use.

It has now been discovered that cracking of a coating during a shaping process of a paperboard bottom blank can be reduced by a new design for a cup bottom disc punch that provides room for or controls formation of a folded edge of the paperboard bottom blank to minimize coating damage and/or control propagation and amplitude of wrinkling, thus reducing beverage staining or leaking along the cup bottom. The punch design modifications of the present description allow for less-flexible, more brittle, or less strong aqueous coatings to survive the shaping process with less cracking.

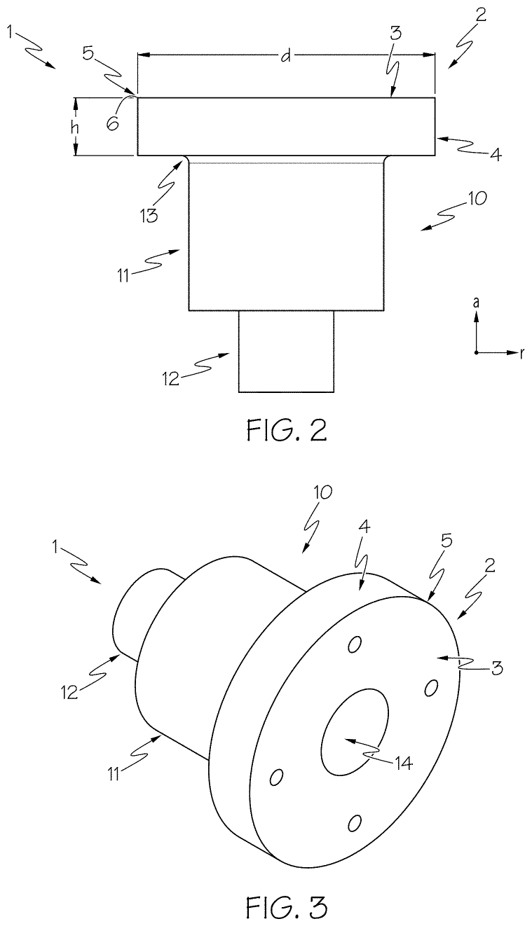

FIGS. 2 and 3 illustrate a control punch 1 for shaping a paperboard bottom blank to shape a peripheral skirt portion about a periphery of the paperboard bottom blank according to a comparative example. The punch 1 includes a cylindrical punch head 2 and a punch support 10 supporting the punch head 2.

The cylindrical punch head 2 includes a punch face 3 extending in a radial direction r about an axis a of the punch head 2 and a sidewall 4 extending in the axial direction a about a periphery of the punch face 3. For the control punch of FIGS. 2 and 3, the height h of the punch head along the punch axial direction is 0.438 inch. and the diameter d of the punch head is 2.301 inch. As shown in FIGS. 2 and 3, the border 5 of the punch face 3 and the sidewall 4 is defined as a single edge 6 extending around the punch face 3.

The punch support 10 includes a first punch support portion 11 and a second punch support portion 12. The first punch support portion 11 has a diameter smaller than a diameter of the punch head 2, and the second punch support portion 12 has a diameter smaller than a diameter of the first punch support portion 11. The first punch support portion 11 functions to provide direct support to the punch head 2, and the second punch support portion 12 functions to facilitate engagement to a punch apparatus (not shown) for moving the punch head 2 in an axial direction a. The second punch support portion 12 includes a rounded radius 13 for distributing a load between the second punch support portion 12 and the punch head 2. The punch support 10 further includes an axial bore 14 to facilitate engagement to a punch apparatus (not shown). The axial bore 14 extends in the axial direction a through the second punch support portion 12, the first punch support portion 11, and the punch head 2. The axial bore 14 includes a conventional engagement feature (not shown) to facilitate engagement of the punch 1 to the punch apparatus for moving the punch 1.

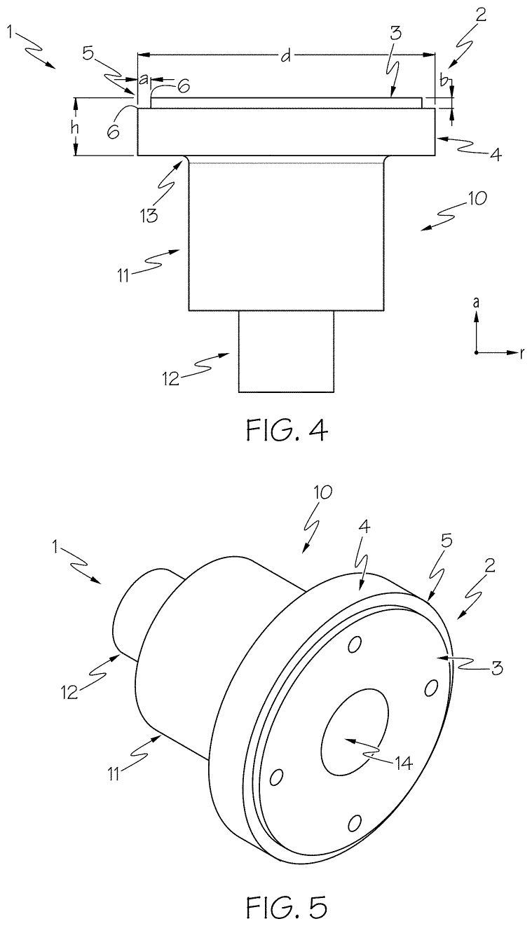

FIGS. 4 to 7 relate to a cylindrical punch head of the first embodiment of the present description.

FIGS. 4 and 5 illustrate a punch 1 for shaping a paperboard bottom blank to shape a peripheral skirt portion about a periphery of the paperboard bottom blank according to a first example of the present description. The punch 1 includes a cylindrical punch head 2 having diameter d and height h and a punch support 10 supporting the punch head 2. Although details of the punch support 10 are described below, the punch support 10 may be omitted or details of the punch support 10 may be omitted or varied depending on design of the punch apparatus.

Referring to FIGS. 4 and 5, the punch support 10 may include a first punch support portion 11 and a second punch support portion 12. The first punch support portion 11 may have a diameter smaller than the diameter d of the punch head 2, and the second punch support portion 12 may have a diameter smaller than a diameter of the first punch support portion 11. The first punch support portion 11 may function to provide direct support to the punch head 2, and the second punch support portion 12 may function to facilitate engagement to a punch apparatus (not shown) for moving the punch head 2 in an axial direction a. The second punch support portion 12 may include a rounded radius 13 for distributing a load between the second punch support portion 12 and the punch head 2. The punch support 10 may further include an axial bore 14 to facilitate engagement to a punch apparatus (not shown). The axial bore 14 may extend in the axial direction a through the second punch support portion 12, the first punch support portion 11, and/or the punch head 2. The axial bore 14 may include a conventional engagement feature (not shown) to facilitate engagement of the punch 1 to the punch apparatus for moving the punch 1.

As shown in FIGS. 4 and 5, the cylindrical punch head 2 includes a punch face 3 extending in a radial direction r about an axis a of the punch head 2, a sidewall 4 extending in the axial direction a about a periphery of the punch face 3, and a stepped border 5 of the punch face 3 and the sidewall 4. The stepped border 5 is a single stepped border. The single stepped border 5 preferably includes a plurality of edges 6 extending around the punch face 3.

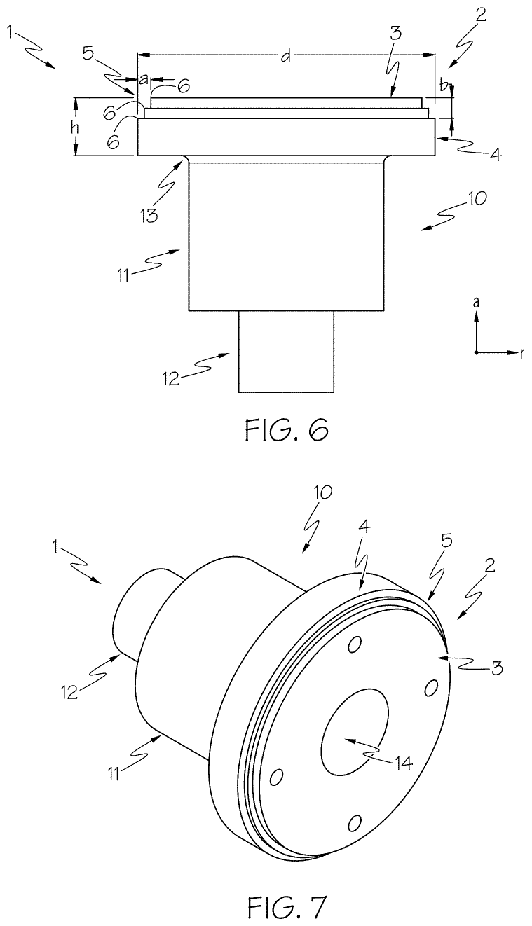

FIGS. 6 and 7 illustrate a punch 1 for shaping a paperboard bottom blank to shape a peripheral skirt portion about a periphery of the paperboard bottom blank according to a second example of the present description. The punch 1 includes a cylindrical punch head 2 and a punch support 10 supporting the punch head 2. A description of the punch support 10 may be referenced above with respect to the description of the punch 1 of the first example of FIGS. 4 and 5.

As shown in FIGS. 6 and 7, the cylindrical punch head 2 includes a punch face 3 extending in a radial direction r about an axis a of the punch head 2, a sidewall 4 extending in the axial direction a about a periphery of the punch face 3, and a stepped border 5 of the punch face 3 and the sidewall 4. The stepped border 5 is a multi-stepped border. In the illustrated example, the multi-step border has two steps. However, the multi-stepped border may have a number of steps greater than two. In a preferred example, the multi-stepped border has a number of steps in a range of 2 to 5 steps. The multi-stepped border 5 preferably includes a plurality of edges 6 extending around the punch face 3.

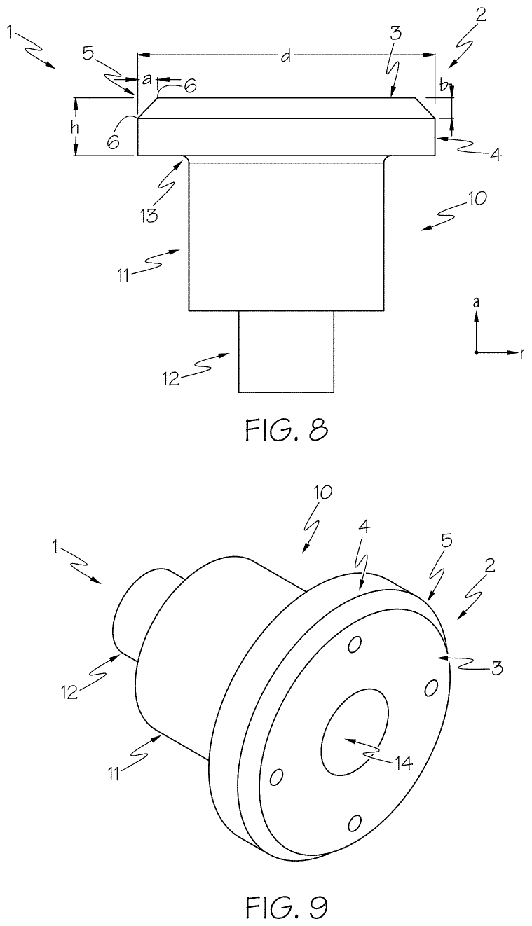

FIGS. 8 and 9 relate to a cylindrical punch head of the second embodiment of the present description.

FIGS. 8 and 9 illustrate a punch 1 for shaping a paperboard bottom blank to shape a peripheral skirt portion about a periphery of the paperboard bottom blank according to a third example of the present description. The punch 1 includes a cylindrical punch head 2 and a punch support 10 supporting the punch head 2. A description of the punch support 10 may be referenced above with respect to the description of the punch 1 of the first example of FIGS. 4 and 5.

As shown in FIGS. 8 and 9, the cylindrical punch head 2 includes a punch face 3 extending in a radial direction r about an axis a of the punch head 2, a sidewall 4 extending in the axial direction a about a periphery of the punch face 3, and a beveled border 5 of the punch face 3 and the sidewall 4. The beveled border 5 preferably includes a plurality of edges 6 extending around the punch face.

The punch has been described above with reference to the first example having a single stepped border as illustrated in FIGS. 4 and 5, the second example having a multi-stepped border as illustrated in FIGS. 6 and 7, and the third example having a beveled border as illustrated in FIGS. 8 and 9. However, the present description may include punches having borders that vary from the above-described stepped and beveled borders.

In particularly, a cylindrical punch head of the third embodiment of the present description may include a punch face extending in a radial direction about an axis of the punch head, a punch sidewall extending in the axial direction of the punch head about a periphery of the punch face, and a border 5 of the punch face and the punch sidewall, in which the border 5 includes a plurality of edges 6 extending around the punch face. The plurality of edges 6 may have any number of edges 6 greater than two. The plurality of edges 6 may be edges 6 of a single stepped border 5 as illustrated in FIGS. 4 and 5. The plurality of edges 6 may be edges 6 of a multi-stepped border 5 as illustrated in FIGS. 6 and 7. The plurality of edges 6 may be edges 6 of a beveled border 5 as illustrated in FIGS. 8 and 9. Thus, the cylindrical punch head of the third embodiment of the present description encompasses the exemplary cylindrical punches as illustrated in FIGS. 4 to 9 and includes additional punches having borders that vary from the above-described and illustrated stepped and beveled borders.

In the present description, edges are portions having a low radius of curvature relative to the adjacent surfaces for which the edges serve as a transition. In an example, the edges may have a radius of curvature less than 0.1 inch. In another example, the edges may have a radius of curvature less than 0.01 inch. In yet another example, the edges may have a radius of curvature less than 0.001 inch. In yet another example, the edges may have a radius of curvature less than 0.0001 inch. In the illustrated examples of FIGS. 4 to 9, the edges are represented as a single point having a substantially zero radius of curvature. The plurality of edges of the present description believed to contribute to allowing the coatings to survive the shaping process with less cracking. Thus, the cylindrical punches of the present description, whether stepped, beveled, or otherwise, are preferred to include the plurality of edges extending around the punch face.

Additional aspects of the punch head of the present description are described as follows.

The sidewall height h in the axial direction of the punch head may be controlled. If the sidewall height h in the axial direction of the punch head is too low, then it may be insufficient to shape a peripheral skirt. If the sidewall height h in the axial direction of the punch head is too high, then the excess height of the peripheral skirt may not create an advantage and it may cause design constraint problems for the punch head. In an aspect, the sidewall height h in the axial direction of the punch head may be 0.1 to 2.0 inch. In another aspect, the sidewall height h in the axial direction of the punch head may be 0.3 to 0.5 inch.

The punch head diameter d may be controlled depending on a desired diameter of a resulting bottom wall of a paperboard bottom blank. In an aspect, a punch face top diameter d may be between 1 and 8 inch. In another aspect, a punch head diameter d may be between 2 and 3 inch.

Additional aspects of the stepped or beveled border of the present description are described as follows.

In an aspect of the present description, the stepped or beveled border of the present description may preferably have a total radial width in a range of about 0.0075d to about 0.075d, wherein d is a diameter of the punch face. In another aspect of the present description, the stepped or beveled border of the present description may preferably have a total radial width in a range of about 0.04h to about 0.4h, wherein h is a axial height of the punch sidewall. If the total radial width is too low, then a sufficient effect of the present description towards reducing cracking may not be achieved, and, thus, the stepped or beveled punch may substantially function similar to the control punch 1 of FIGS. 2 and 3. If the total radial width is too high, then the overall shape of the resulting shaped paperboard bottom blank may be varied too much, and the shaped paperboard bottom blank may not satisfactorily function as a container bottom.

In an aspect of the present description, the stepped or beveled border of the present description may preferably have a total axial height in a range of about 0.0075d to about 0.075d, wherein d is a diameter of the punch face. In another aspect of the present description, the stepped or beveled border of the present description may preferably have a total axial height in a range of about 0.04h to about 0.4h, wherein h is a axial height of the punch sidewall. If the total axial width is too low, then a sufficient effect of the present description towards reducing cracking may not be achieved, and, thus, the stepped or beveled punch may substantially function similar to the control punch 1 of FIGS. 2 and 3. If the total axial width is too high, then the overall shape of the resulting shaped paperboard bottom blank may be varied too much, and the shaped paperboard bottom blank may not satisfactorily function as a container bottom.

In yet another aspect of the present description, a ratio of a total radial width to a total axial height of the border is in a range of 1:10 to 10:1. If the ratio of the total radial width to the total axial height of the border is too high or too low, then a sufficient effect of the present description towards reducing cracking may not be achieved, and, thus, the stepped or beveled punch may substantially function similar to the control punch 1 of FIGS. 2 and 3.

In an example, the cylindrical punch head may be designed for shaping of paperboard cup bottom blanks of a typical conventional size, such as for holding of coffee or other drinks. In an aspect, an axial height of the sidewall may be in a range of about 0.1 to about 2.0 inch, more preferably in a range of about 0.3 to about 0.5 inch. In another aspect, a diameter of the punch face may be in a range of about 1 to about 8 inch, preferably in a range of about 2 to about 3 inch. In another aspect, the stepped border may have a total radial width in a range of about 0.02 to about 0.18 inch. In another aspect, the stepped border may have a total axial height in a range of about 0.02 to about 0.18 inch.

In a first specific example of a single stepped cylindrical punch head as illustrated in FIGS. 4 and 5, the height h of the punch head along the punch axial direction may be 0.438 inch, the diameter d of the punch head may be 2.301 inch, the total radial width of a single stepped border may be 0.101 inch, and the total axial width of the single stepped border may be 0.063 inch.

In a second specific example of a multi-stepped cylindrical punch head as illustrated in FIGS. 6 and 7, the height h of the punch head along the punch axial direction may be 0.438 inch, the diameter d of the punch head may be 2.301 inch, the total radial width of a multi-stepped border may be 0.125 inch, and the total axial width of the multi-stepped border may be 0.125 inch.

In a third specific example of a beveled cylindrical punch head as illustrated in FIGS. 8 and 9, the height h of the punch head along the punch axial direction may be 0.438 inch, the diameter d of the punch head may be 2.301 inch, the total radial width of a beveled border may be 0.156 inch, and the total axial width of the beveled border may be 0.156 inch.

Additional aspects of the border having a plurality of edges extending around the punch face of the present description are described as follows.

In an aspect of the present description, a total radial distance between the first edge and the last edge of the plurality of edges may be in a range of about 0.0075d to about 0.075d, wherein d is a diameter of the punch head. In another aspect, a total radial distance between the first edge and the last edge of the plurality of edges may be in a range of about 0.04h to about 0.4h, wherein h is a axial height of the punch sidewall. If the total radial distance is too low, then a sufficient effect of the present description towards reducing cracking may not be achieved, and, thus, the punch may substantially function similar to the control punch 1 of FIGS. 2 and 3. If the total radial distance is too high, then the overall shape of the resulting shaped paperboard bottom blank may be varied too much, and the shaped paperboard bottom blank may not satisfactorily function as a container bottom.

In an aspect of the present description, a total axial distance between the first edge and the last edge of the plurality of edges may be in a range of about 0.0075d to about 0.075d, wherein d is a diameter of the punch head. In another aspect, a total axial distance between the first edge and the last edge of the plurality of edges may be in a range of about 0.04h to about 0.4h, wherein h is a axial height of the punch sidewall. If the total axial distance is too low, then a sufficient effect of the present description towards reducing cracking may not be achieved, and, thus, the punch may substantially function similar to the control punch 1 of FIGS. 2 and 3. If the total axial distance is too high, then the overall shape of the resulting shaped paperboard bottom blank may be varied too much, and the shaped paperboard bottom blank may not satisfactorily function as a container bottom.

In yet another aspect, a ratio of a total radial distance between the first edge and the last edge of the plurality of edges and a total axial distance between the first edge and the last edge may be in a range of 1:10 to 10:1. If the ratio of the total radial distance to the total axial distance of the border is too high or too low, then a sufficient effect of the present description towards reducing cracking may not be achieved, and, thus, the punch may substantially function similar to the control punch 1 of FIGS. 2 and 3.

In an example, the cylindrical punch head may be designed for shaping of paperboard cup bottom blanks of a typical conventional size, such as for holding of coffee or other drinks. In an aspect, an axial height of the sidewall may be in a range of about 0.1 to about 2.0 inch, more preferably in a range of about 0.3 to about 0.5 inch. In another aspect, a diameter of the punch face may be in a range of about 1 to about 8 inch, preferably in a range of about 2 to about 3 inch. In another aspect, a total radial distance between the first edge and the last edge of the plurality of edges may be in a range of about 0.02 to about 0.18 inch. In another aspect, a total axial distance between the first edge and the last edge of the plurality of edges may be in a range about 0.02 to about 0.18 inch.

In a first specific example as illustrated in FIGS. 4 and 5, the height h of the punch head along the punch axial direction may be 0.438 inch, the diameter d of the punch head may be 2.301 inch, the total radial distance between the first edge and the last edge of the plurality of edges may be 0.101 inch, and the total axial distance between the first edge and the last edge of the plurality of edges may be 0.063 inch.

In a second specific example as illustrated in FIGS. 6 and 7, the height h of the punch head along the punch axial direction may be 0.438 inch, the diameter d of the punch head may be 2.301 inch, the total radial distance between the first edge and the last edge of the plurality of edges may be 0.125 inch, and the total axial distance between the first edge and the last edge of the plurality of edges may be 0.125 inch.

In a third specific example as illustrated in FIGS. 8 and 9, the height h of the punch head along the punch axial direction may be 0.438 inch, the diameter d of the punch head may be 2.301 inch, the total radial distance between the first edge and the last edge of the plurality of edges may be 0.156 inch, and the total axial distance between the first edge and the last edge of the plurality of edges may be 0.156 inch.

The cylindrical punch faces, whether stepped, beveled, or otherwise, of the present description may include additional variations and alterations, some examples of which are described as follows.

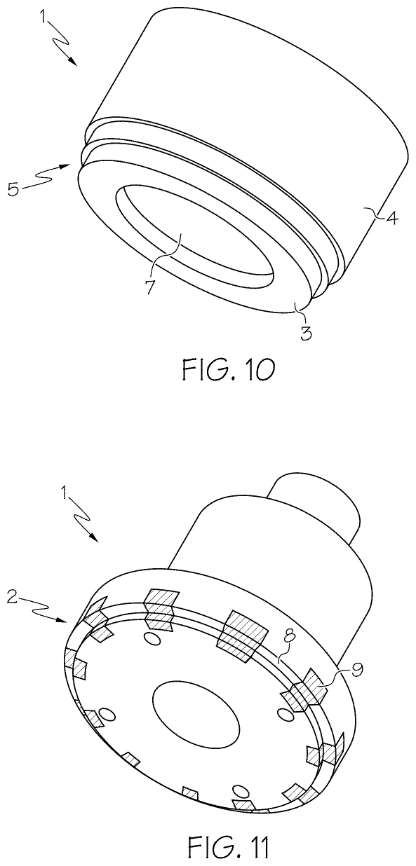

FIG. 10 illustrates an exemplary punch 1 having a multi-stepped border 5 between a punch face 3 and sidewall 4 and having a center recess 7 in the punch face 3. Although the center recess is shown with a multi-stepped border, the center recess may be employed with a single stepped border, a beveled border, or any other border within the scope of the present description.

FIG. 11 illustrates an exemplary punch 1 formed from a combination of materials. While punches may typically be manufactured from a single monolithic material as illustrated in FIGS. 4 to 10, it is possible that advantages may be gained by using a combination of materials as illustrated in FIG. 11, such as alternating portions of lower friction material 8 and higher friction material 9 spaced about the border of the punch head 2. It may be further advantageous to have alternating friction zones within the punch cavity as well.

In another exemplary alteration of the present description (not shown), the sidewall may define plurality of grooves extending in the axial direction of the punch head. By including the plurality of grooves defined in the sidewall, the resulting paperboard may be provided with guide points for more controlled wrinkle formation and propagation and corresponding alleviation of coating stress.

In another exemplary alteration of present description (not shown), the sidewall may include a sidewall taper, such the sidewall is tapered with respect to the axial direction. For example, the sidewall may have a sidewall taper ratio of between about 0.8 and about 1.2.

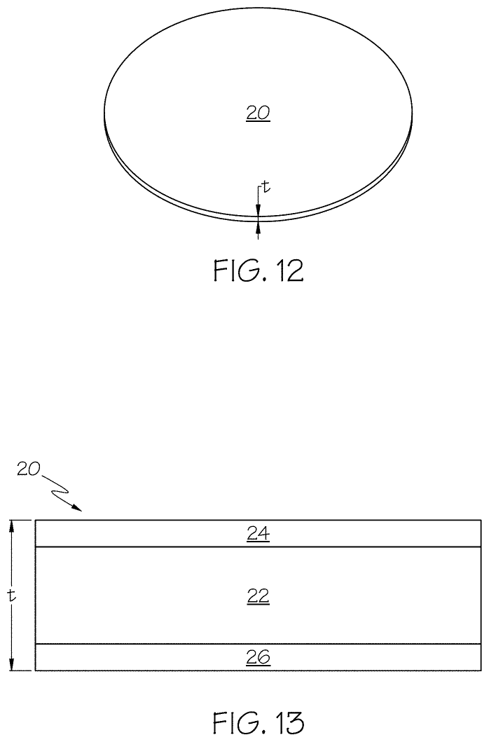

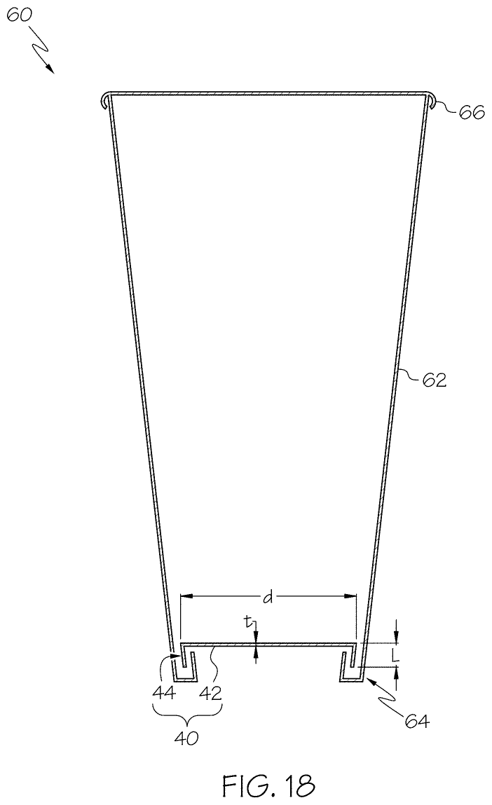

The punch head of the present description may be used with a method for shaping a paperboard bottom blank. The method may include providing a paperboard bottom blank 20 having a caliper thickness t (see FIGS. 12 and 13) and shaping the paperboard bottom blank 20 using a cylindrical punch head of the present description, thereby shaping a bottom wall 42 having a diameter d and a peripheral skirt 44 having a skirt height L (see FIG. 18) about a periphery of the bottom wall 42 of the shaped paperboard bottom blank 40.

Referring to FIGS. 12 and 13, the paperboard bottom blank 20 may include a layered structure that includes a paperboard substrate 22 having a first major side and a second major side, a first barrier coating layer 24 applied to the first major side of the paperboard substrate 22 and a second barrier coating layer 26 applied to the second major side of the paperboard substrate 22. However, the layered structure of the coated paperboard bottom blank 20 is not limited to the illustrated example. In any case, the caliper thickness t of the coated paperboard bottom blank is considered to include the entire thickness of the coated paperboard bottom blank from a first outermost surface to an opposing second outermost surface.

Referring to the example illustrated in FIGS. 12 and 13, the first barrier coating layer 24 may define a first outermost surface of the coated paperboard bottom blank 20 and the second barrier coating layer 26 may define a second outermost surface of the coated paperboard bottom blank 20.

At this point, those skilled in the art will appreciate that various additional layers may be incorporated into the coated paperboard bottom blank 20 without departing from the scope of the present disclosure. In one variation, the coated paperboard bottom blank 20 may include a first basecoat between the paperboard substrate 22 and the first barrier coating layer 24, and the coated paperboard bottom blank 20 may include a second basecoat between the paperboard substrate 22 and the second barrier coating layer 26, or a third topcoat on top of the second barrier coating layer 26. In another variation, the coated paperboard bottom blank 20 may only include only a first barrier coating layer 24 on the paperboard substrate 22 without the second barrier coating layer 26.

The paperboard substrate 22 of the coated paperboard bottom blank 20 may be (or may include) any cellulosic material that is capable of being coated with the barrier coating layers. Those skilled in the art will appreciate that the paperboard substrate 22 may be bleached or unbleached. Examples of appropriate paperboard substrates include corrugating medium, linerboard, solid bleached sulfate (SBS), folding box board (FBB), and uncoated unbleached kraft (UUK).

The paperboard substrate 22 may have an uncoated basis weight of at least about 40 pounds per 3000 ft2. In one expression the paperboard substrate 22 may have an uncoated basis weight ranging from about 40 pounds per 3000 ft2 to about 300 pounds per 3000 ft2. In another expression the paperboard substrate 22 may have an uncoated basis weight ranging from about 85 pounds per 3000 ft2 to about 300 pounds per 3000 ft2. In another expression the paperboard substrate 22 may have an uncoated basis weight ranging from about 85 pounds per 3000 ft2 to about 250 pounds per 3000 ft2. In yet another expression the paperboard substrate 22 may have an uncoated basis weight ranging from about 100 pounds per 3000 ft2 to about 250 pounds per 3000 ft2.

Furthermore, the paperboard substrate 22 may have a caliper (thickness) ranging, for example, from about 4 points to about 30 points (0.004 inch to 0.030 inch). In one expression, the caliper range is from about 8 points to about 16 points. In another expression, the caliper range is from about 10 points to about 13 points.

The first barrier coating layer 24 and second barrier coating layer 26 may be applied using any suitable method, such as one or more coaters either on a paper machine or as off-machine coater(s) such that the first barrier coating layer 24 and second barrier coating layer 26 are formed on the exposed, outermost surfaces of the paperboard substrate 22. In an aspect, the first barrier coating layer 24 and the second barrier coating layer 26 may be heat-sealable barrier coating layers. When heated, a heat-seal coating provides an adhesion to other regions of a product (e.g. sidewall of a container) with which it contacts.

The first barrier coating layer 24 and second barrier coating layer 26 may be applied to the paperboard substrate 22 at various coat weights. As one, non-limiting example, the first barrier coating layer 24 and second barrier coating layer 26 may be applied at a coat weight of about 2 to 20 pounds per 3,000 square feet. As another, non-limiting example, the first barrier coating layer 24 and second barrier coating layer 26 may be applied at a coat weight of about 4 to 14 pounds per 3,000 square feet.

The first barrier coating layer 24 and second barrier coating layer 26 may include a binder and a pigment. In one expression, the ratio of the binder to the pigment can be at least about 1:2 by weight. In another expression, the ratio of the binder to the pigment can be about 1:2 to about 9:1 by weight. In another expression, the ratio of the binder to the pigment can be about 1:1 to about 4:1 by weight. In yet another expression, the ratio of the binder to the pigment can be at least about 1:1 by weight.

The binder may be an aqueous binder. As one general, non-limiting example, the binder may be styrene-acrylate (SA) (i.e., the binder “consists of” or “consists essentially of” styrene-acrylate (SA)). As another general, non-limiting example, the binder may be a mixture of binders that includes styrene-acrylate (SA). Other aqueous binders are also contemplated, such as styrene-butadiene rubber (SBR), ethylene acrylic acid (EAA), polyvinyl acrylic, polyvinyl acetate (PVAC), polyester dispersion, and combinations thereof.

In one variation, the pigment may be a clay pigment. As one example, the clay pigment may be kaolin clay, such as a fine kaolin clay. As another example, the clay pigment may be platy clay, such as a high aspect ratio platy clay (e.g., aspect ratio of at least 40:1). In another variation, the pigment may be a calcium carbonate (CaCO3) pigment. In yet another variation, the pigment may be a pigment blend that includes both calcium carbonate pigment and clay pigment.

A method for shaping a paperboard bottom blank includes providing a paperboard bottom blank having a caliper thickness t, and shaping the paperboard bottom blank using the stepped or beveled cylindrical punch head as described, thereby shaping paperboard bottom blank to form a bottom wall and a peripheral skirt having a skirt height L about a periphery of the bottom wall of the paperboard bottom blank.

Aspects of the stepped or beveled border of the present description may relate to characteristics of the paperboard bottom blank as follows.

In an aspect, the stepped or beveled border may have a total radial width in a range of about 0.04L to about 0.4L. In another aspect, the stepped or beveled border may have a total radial width in a range of about 1t to 20t. If the total radial width is too low, then a sufficient effect of the present description towards reducing cracking may not be achieved, and, thus, the stepped or beveled punch may substantially function similar to the control punch 1 of FIGS. 2 and 3. If the total radial width is too high, then the overall shape of the resulting shaped paperboard bottom blank may be varied too much, and the shaped paperboard bottom blank may not satisfactorily function as a container bottom.

In an aspect, the stepped or beveled border may have a total axial width in a range of about 0.04L to about 0.4L. In another aspect, the stepped or beveled border may have a total axial width in a range of about 1t to 20t. If the total axial width is too low, then a sufficient effect of the present description towards reducing cracking may not be achieved, and, thus, the stepped or beveled punch may substantially function similar to the control punch 1 of FIGS. 2 and 3. If the total axial width is too high, then the overall shape of the resulting shaped paperboard bottom blank may be varied too much, and the shaped paperboard bottom blank may not satisfactorily function as a container bottom.

In an aspect, a sidewall height h in the axial direction of the punch head may be controlled relative to the skirt height L of the paperboard bottom blank. If the sidewall height h in the axial direction of the punch head is too low compared to the skirt height L of the paperboard bottom blank, then it may be insufficient to shape a peripheral skirt. If the sidewall height h in the axial direction of the punch head is too high, then an excess height of the peripheral skirt may not create an additional advantage and it may cause design constraint problems for the punch head. In an preferred aspect, the sidewall height h in the axial direction of the punch head is between 0.8 and 1.2 times the skirt height h of the peripheral skirt of the paperboard bottom blank. In an specific aspect, the skirt height of the paperboard bottom blank may be in a range of about 0.1 to about 2.0 inch, more preferably in a range of about 0.3 to about 0.5 inch. In another aspect, a diameter of the bottom wall of the paperboard bottom blank may be in a range of about 1 to about 8 inch, preferably in a range of about 2 to about 3 inch.

The method for shaping a paperboard bottom blank may further include heating the coated paperboard bottom blank. By heating the coated paperboard bottom blank before or during the shaping process, cracking of a coating during a shaping process of a coated paperboard bottom blank can be reduced. Although the invention is not limited by theory, it is believed that heating the coated paperboard bottom blank may increase a pliability of a barrier coating layer on a paperboard substrate and/or may increase a pliability of the paperboard substrate to relieve a stress transfer between the barrier coating layer and the paperboard substrate during a shaping process. For conventional polyethylene extrusion coated paperboard, heating of the polyethylene coating is typically unnecessary due to excellent flexibility of the polyethylene extrusion coating.

Additionally, the heating of the coated paperboard bottom blank may include applying moisture (e.g., steam) to the paperboard bottom blank before or during the step of shaping the paperboard bottom blank using the punch head 2 of the present description. It has been found that cracking during a shaping process has been even further reduced by applying moisture (e.g., steam) rather than just heat. The application of moisture to the coated paperboard bottom blank is not limited by any particular process. In one variation, the application of moisture to the coated paperboard bottom blank may include applying steam to the coated paperboard bottom blank using a non-contact heating, such as a hot moist air blower. In another variation, the application of moisture to the coated paperboard bottom blank may include contacting the coated paperboard bottom blank with a water and then a heated die during a process for shaping the heated coated paperboard bottom blank. In an aspect, the method may omit the step of applying moisture to the coated paperboard bottom blank.

An exemplary method includes applying steam to the coated paperboard bottom blank and shaping the resulting paperboard bottom blank using the punch head of the present description. However, the punch head of the present description may be employed with or without heating, and with or without application of steam.

In an aspect, the method may be performed by a cup bottom forming apparatus. The cup bottom forming apparatus includes a punching assembly for shaping the coated paperboard bottom blank to form a peripheral skirt portion about a periphery of a bottom wall portion of the coated paperboard bottom blank and an optional heater positioned to heat the coated paperboard bottom blank prior to and/or during formation of the peripheral skirt portion. The optional heater may optionally apply moisture.

In an aspect, the heater includes a non-contact heater positioned to heat the coated paperboard prior to the punching of the coated paperboard bottom blank.

In another aspect, the heater includes a contact heater positioned to heat a die contacting the coated paperboard within the punching assembly.

The cup bottom forming apparatus may further include a cutting assembly for cutting the coated paperboard bottom blank from a web of coated paperboard.

In an aspect, the heater includes a non-contact heater positioned to heat the coated paperboard prior to the cutting of the coated paperboard bottom blank.

In an aspect, the heater includes a contact heater positioned to heat a die contacting the coated paperboard within the cutting assembly.

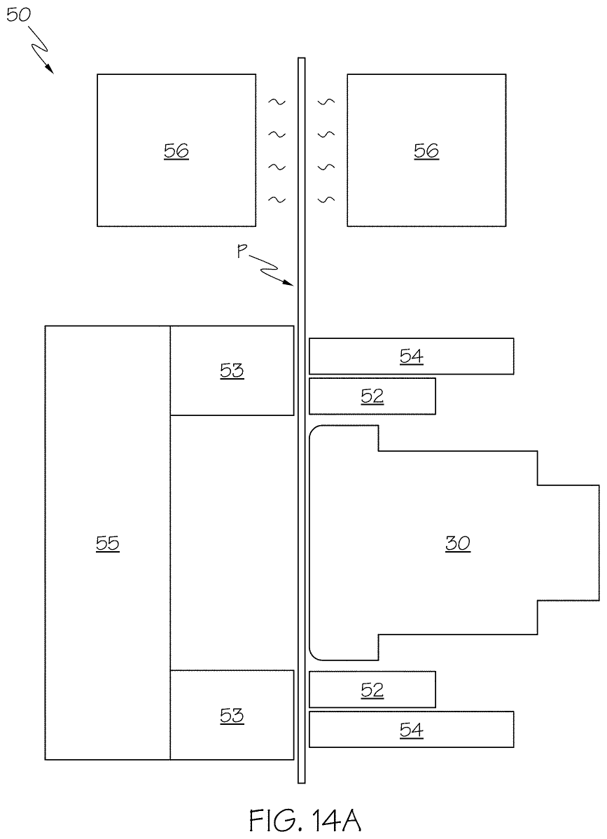

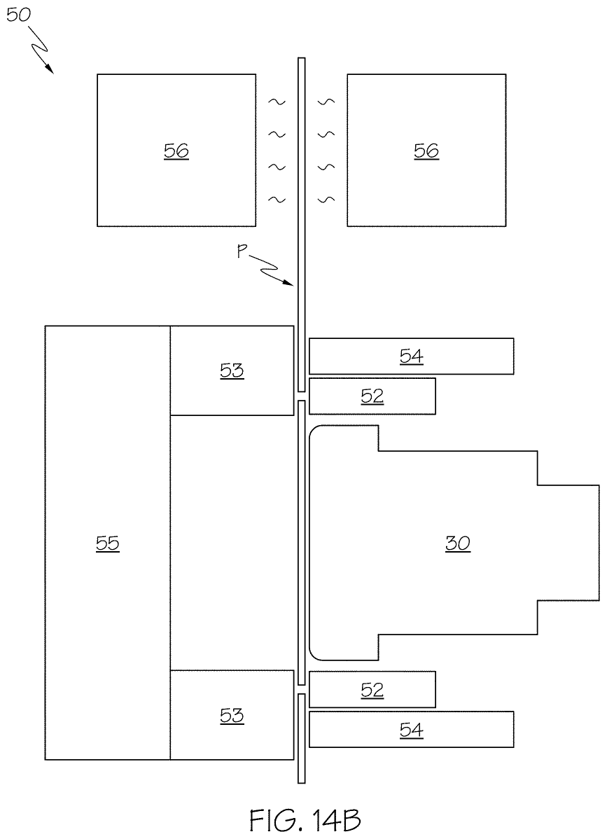

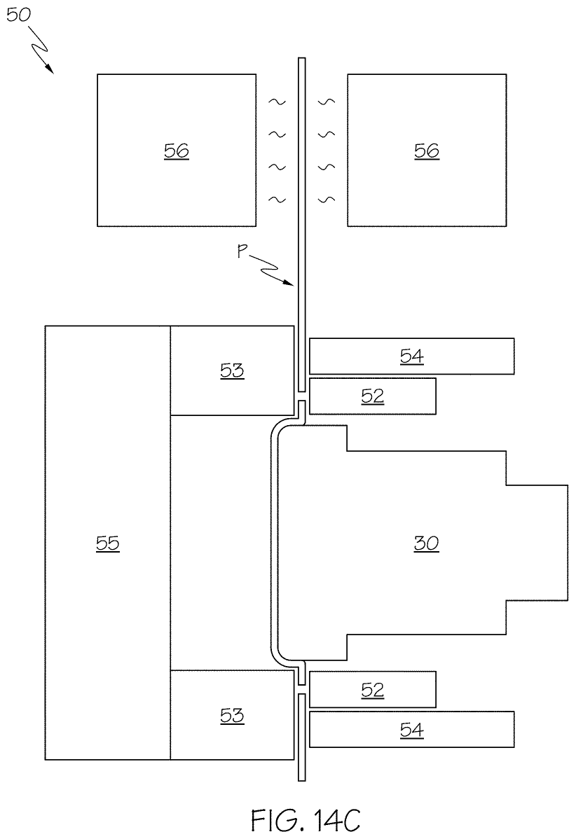

FIGS. 14A, 14B and 14C are schematic views of an exemplary container bottom shaping apparatus 50 for shaping the paperboard bottom blank of FIGS. 12 and 13, in particular a cup bottom forming apparatus for shaping a coated paperboard bottom blank cut from a roll of paper that feeds a strip of paper vertically downward in the illustrated figures. As shown, the cup bottom forming apparatus includes a punch 30 having a cylindrical punch head with a beveled border according to the present description, which forms the peripheral skirt as the punch draws the cut-out blank through the main die 53 having a cylindrical recess for receiving the cylindrical punch head. In an aspect, the cup bottom forming apparatus 50 may further includes cutters 52 for cutting the coated paperboard into a coated paperboard bottom blank, and casing 54. The punch 30 and cutters 52 may be attached to a piston (not shown) to perform their respective functions. Although the punch 30 of FIGS. 14A, 14B and 14C are shown with punch having a beveled border, the punch may instead having a single stepped border, a multi-stepped border, or any other border within the scope of the present description.

In an aspect, the cup bottom forming apparatus 50 may further include a contact heater 55 for heating a die during a process for shaping the heated coated paperboard bottom blank P. It should be understood that the placement of the contact heater is merely illustrative and that any of the dies or tools in the cup bottom forming apparatus 50, including punch 30, contacting the coated paperboard bottom blank P may be heated to affect the heating of the coated paperboard bottom blank P.

In an aspect, the cup bottom forming apparatus 50 may further include non-contact heaters 56 for heating the coated paperboard P. In an example, the non-contact heaters 56 may include a hot air blower blowing heated air to the frontside and/or backside of the coated paperboard P. In another example, the non-contact heaters 56 may include an infrared heater for heating the frontside and/or backside of the coated paperboard P. In another example, the non-contact heaters 56 may include steam applicator (moisture and heat).

In an aspect, the cup bottom forming apparatus 50 may further include contact heaters 56 for heating a die in contact with the coated paperboard P. In an example, the contact heaters 56 may include heating tape held onto the respective dies with heat-reflective metallic tape.

It should be understood that the cup bottom forming apparatus of FIGS. 13A, 13B and 13C is merely representative of one exemplary cup bottom forming apparatus for practicing the invention.

Aspect of the present description relate to a paperboard bottom blank shaped by the methods of the present description. Thus, the shaped paperboard bottom blank may have shapes resulting from being punch with the stepped, beveled, or other cylindrical punch heads within the scope of the present disclosure.

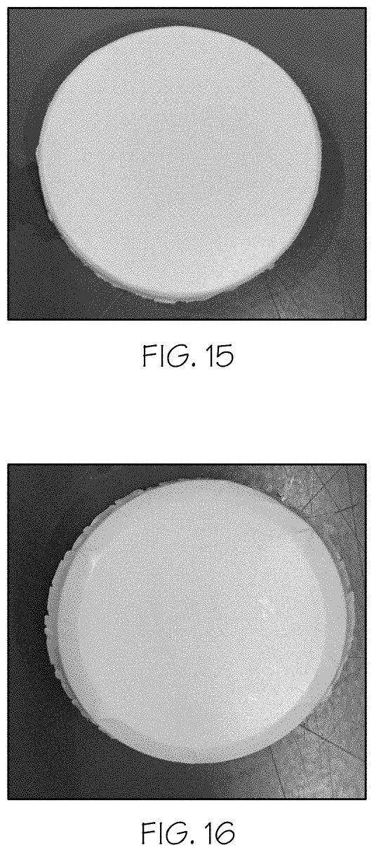

FIG. 15 is a photograph of a paperboard bottom blank after shaping with a control punch according to the comparative example of FIGS. 2 and 3.

FIG. 16 is a photograph of an exemplary paperboard bottom blank after shaping with a punch according to the second example of FIGS. 6 and 7, in which the height h of the punch head along the punch axial direction was 0.438 inch, the diameter d of the punch head was 2.301 inch, the total radial width of a multi-stepped border was 0.125 inch, and the total axial width of the multi-stepped border was 0.125 inch. As shown by FIG. 16, a paperboard bottom blank after shaping with a punch according to the present description has a characteristic difference from the paperboard bottom blank after shaping with a control punch according to the comparative example of FIGS. 2 and 3.

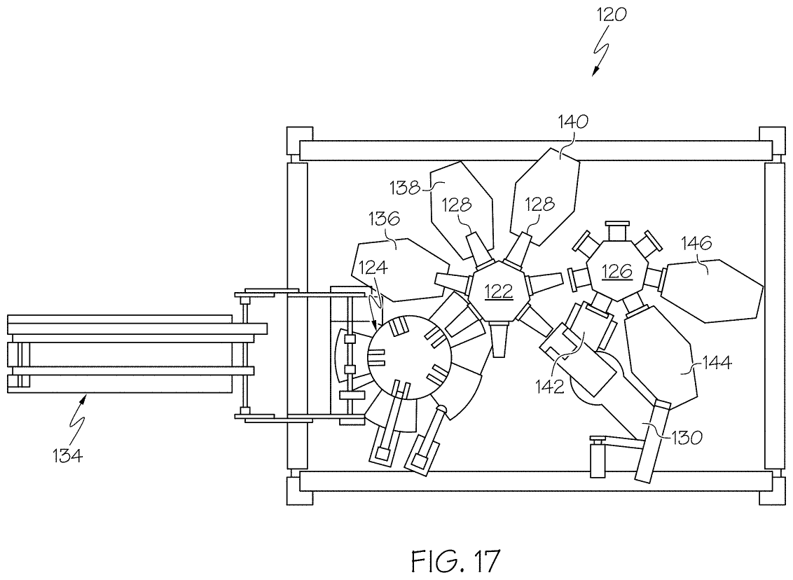

FIG. 17 is a schematic view of an exemplary paperboard container making machine that may include a punch of the of the present description, in particularly a paperboard cup making machine 120.

Referring to FIG. 17, the exemplary cup making machine 120 is illustrated. This exemplary cup making machine 120 includes a mandrel turret 122 which cooperates with a transfer turret 124 and a rimming turret 126. Mandrel turret 122 includes a plurality of mandrels 128 that are rotated between surrounding workstations. For example, a bottom blank is cut and shaped using a punch of the present disclosure at a bottom blank workstation 130. From this point, a mandrel 128 holding the cut and shaped bottom blank from the bottom blank workstation 130 is rotated into cooperation with the sidewall station which receives sidewall blanks from a hopper 134 and rotates a sidewall blank into cooperation with the cooperating mandrel 128. The sidewall blank is then folded about the mandrel 128 over the bottom blank, heated and sealed along a seam.

Next, the bottom blank and sidewall blank are rotated to a bottom heat station 136. After heating, mandrel turret 122 indexes the subject mandrel 128 to a roller in curl station 138 where a portion of the sidewall blank, i.e. a sidewall blank flap, is bent over an outer lip of the bottom blank to form a recessed bottom in the cup. The cup is then moved to a bottom finish station 140 where the sidewall blank flap and the bottom blank lip are pressed against the lower region of the sidewall blank to form a seal.

Once the bottom is formed and sealed, the cup is transferred to rimming turret 126 and rotated to a lube station 142 and then to a rimming precurl station 144 where the upper lip of the sidewall is curled outwardly. From that station, the cup is indexed to a rimming finish curl station 146 which finishes the curled portion along the top of the cup to make an attractive edge.

The above-described paperboard cup making machine 120 is one exemplary design of many paperboard container making machines that could incorporate the punch according to the present disclosure. Different arrangements of workstations may be used on other paperboard container making machines. For example, some cup making machines may cut and shape a bottom blank at separate workstations. All are equally adaptable, to incorporate the punch of the present disclosure.

Aspects of the present description relate to paperboard containers (e.g. paperboard cups) formed from a paperboard bottom blank shaped by the cylindrical punch head of the present description.

FIG. 18 is a sectional schematic view of a representation of a coated paperboard container (e.g. paperboard cup) according to an example of the present description.

As shown in FIG. 18, the coated paperboard container 60 includes a coated paperboard bottom 40 and a coated paperboard sidewall 62. The coated paperboard bottom 40 includes a paperboard substrate and a first barrier coating layer on an outermost surface of the paperboard substrate (see FIGS. 12 and 13) and the coated paperboard bottom 40 includes peripheral skirt portion 44 formed about a periphery of a bottom wall portion 42. The coated paperboard sidewall 62 is sealed to the first barrier coating layer of the peripheral skirt portion 44.

In an aspect, the paperboard bottom further includes a second barrier coating layer on another outermost surface of the paperboard substrate, and the coated paperboard sidewall may be sealed to the second barrier coating layer of the peripheral skirt portion. For example, as illustrated, a bottom portion of the paperboard sidewall may be folded over the peripheral skirt and bonded (e.g. heat-sealed) to both sides of the peripheral skirt.

In an aspect, the interior surface of the coated paperboard sidewall may include a barrier coating at an outermost surface thereof. For example, the barrier coating may the same as one or both of the barrier coatings on the paperboard bottom. In an aspect, the barrier coating may comprise an aqueous binder, such as styrene-acrylate.

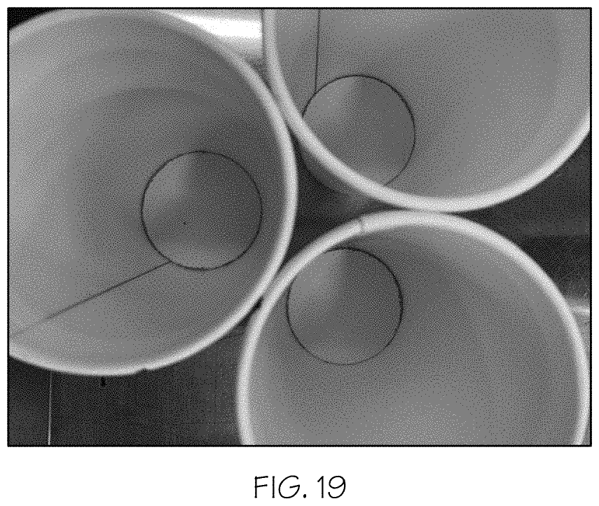

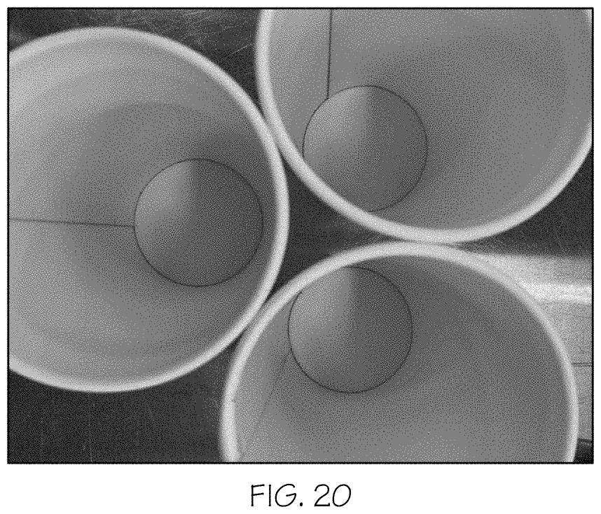

FIG. 19 is a photograph of a paperboard container formed from a paperboard bottom blank shaped using a control punch according to the comparative example of FIGS. 2 and 3. FIG. 20 is a photograph of a paperboard container formed from a paperboard bottom blank shaped using a punch according to the second example of FIGS. 6 and 7, in which the height h of the punch head along the punch axial direction was 0.438 inch, the diameter d of the punch head was 2.301 inch, the total radial width of a multi-stepped border was 0.125 inch, and the total axial width of the multi-stepped border was 0.125 inch.

To form the paperboard container of FIGS. 19 and 20, coated paperboard samples included 13 pt (1 pt=0.001″) and 18pt solid bleached sulfate (SBS) cupstock substrate manufactured by WestRock Company of Atlanta, Ga., which was coated with two layers of a heat-sealable barrier coating. The heat-sealable barrier coating formulation contained HYDROCARB® 60 (Omya AG of Oftringen), BARRISURF™ XP (IMERYS Kaolin), and CARTASEAL® SCR (Archroma) at a ratio of 65/35/250 by weight. The 13 pt cupstock was coated with two layers of the barrier coating on the felt side at a total coat weight of 11.3 lb/3000F2 and was used as bottom stock for the cup containers, and the 18 pt cupstock coated with two layers of the barrier coating on the felt side at a total coat weight of 11.9 lb/3000F2 was used as side wall for the cup containers. The coated barrier side was facing inside of the cup for both the cup bottom and the side wall.

The cups were made on a PMC (Paper Machinery Corporation) cup machine, model PMC-1250, using the control punch of FIGS. 2 and 3 and the multi-stepped border punch of FIGS. 6 and 7. More specifically, the control cups of FIG. 19 were formed using a standard control punch head substantially as shown in FIGS. 2 and 3 to shape heated paperboard bottom blanks, which were then heat sealed to sidewalls. The cups of FIG. 20 were formed using a punch head substantially as shown in FIGS. 6 and 7, in which the height h of the punch head along the punch axial direction was 0.438 inch, the diameter d of the punch head was 2.301 inch, the total radial width of a multi-stepped border was 0.125 inch, and the total axial width of the multi-stepped border was 0.125 inch, to shape heated paperboard bottom blanks. The shaped paperboard bottom blanks were then heat sealed to sidewalls.

The cups then were evaluated for coffee holdout. Coffee for cup testing was prepared by brewing Starbucks medium house blend ground coffee at a ratio of 36 g coffee powder per 1100 mL of distilled water, setting at a coffee temperature of about 90° C. The coffee was then poured into cups to a level 5 mm below the rim of the cup. After a 30 minute hold, the coffee was removed from the cups and rinsed with distilled water. The empty cups were then immediately evaluated for leakage, staining, or damage.

Referring to FIG. 19, coating cracking and coffee staining was observed on internal cup bottom edge after coffee testing for 30 min. Referring to FIG. 20, no or minimal staining was observed on the internal cup bottom after coffee testing for 30 min. Thus, it has been shown that punch modifications within the scope of the present description can reduce cracking of a coating during a shaping process, thus reducing beverage staining or leaking along the cup bottom.

Although various embodiments of the disclosed methods and coated paperboard containers have been shown and described, modifications may occur to those skilled in the art upon reading the specification. The present application includes such modifications and is limited only by the scope of the claims.

1. A cylindrical punch head for shaping a paperboard bottom blank to shape a peripheral skirt portion about a periphery of the paperboard bottom blank, the cylindrical punch head comprising:
a punch face extending in a radial direction about an axis of the punch head; and
a punch sidewall extending in an axial direction of the punch head about a periphery of the punch face; and
a stepped border of the punch face and the punch sidewall.

2. The cylindrical punch head of claim 1, wherein the stepped border is a single step border.

3. The cylindrical punch head of claim 1, wherein the stepped border is a multi-step border.

4. The cylindrical punch head of claim 1, wherein the stepped border is a multi-step border having a number of steps in a range of 2 to 5 steps.

5. The cylindrical punch head of claim 1, wherein the stepped border has a total radial width in a range of about 0.0075d to about 0.075d, wherein d is a diameter of the punch head.

6. The cylindrical punch head of claim 1, wherein the stepped border has a total radial width in a range of about 0.04h to about 0.4h, wherein h is a axial height of the punch sidewall.

7. The cylindrical punch head of claim 1, wherein the stepped border has a total axial height in a range of about 0.0075d to about 0.075d, wherein d is a diameter of the punch head.

8. The cylindrical punch head of claim 1, wherein the stepped border has a total axial height in a range of about 0.04h to about 0.4h, wherein h is a axial height of the punch sidewall.

9. The cylindrical punch head of claim 1, wherein a ratio of a total radial width to a total axial height of the stepped border is in a range of 1:10 to 10:1.

10. The cylindrical punch head of claim 1, wherein an axial height of the sidewall is in a range of about 0.1 to about 2.0 inch.

11. The cylindrical punch head of claim 1, wherein an axial height of the sidewall is in a range of about 0.3 to about 0.5 inch.

12. The cylindrical punch head of claim 1, wherein a diameter of the punch face is in a range of about 1 to about 8 inch.

13. The cylindrical punch head of claim 1, wherein a diameter of the punch face is in a range of about 2 to about 3 inch.

14. The cylindrical punch head of claim 1, wherein the stepped border has a total radial width in a range of about 0.02 to about 0.18 inch.

15. The cylindrical punch head of claim 1, wherein the stepped border has a total axial height in a range of about 0.02 to about 0.18 inch.

16. A punch comprising:
the cylindrical punch head of claim 1; and
a punch support supporting the cylindrical punch head.

17. A container bottom shaping apparatus for shaping a paperboard bottom blank to shape a peripheral skirt portion about a periphery of the paperboard bottom blank, the apparatus comprising:
the cylindrical punch head of claim 1; and
a die having a cylindrical recess for receiving the cylindrical punch head.

18-19. (canceled)

20. A paperboard container making machine, comprising:
the container bottom shaping apparatus of claim 17;
a mandrel for holding paperboard bottom blank shaped by the container bottom shaping apparatus;
a sidewall station for receiving a sidewall blank and rotating the sidewall blank about the mandrel; and
a heater for heating and sealing the sidewall blank to the bottom blank.

21. A method for shaping a paperboard bottom blank, the method comprising:
providing a paperboard bottom blank having a caliper thickness t;
shaping the paperboard bottom blank using the cylindrical punch head of claim 1, thereby shaping paperboard bottom blank to form a bottom wall and a peripheral skirt having a skirt height L about a periphery of the bottom wall of the paperboard bottom blank.

22-32. (canceled)

33. A paperboard bottom blank shaped by the method of claim 21.

34. A paperboard container comprising:
the shaped paperboard bottom blank of claim 33; and
a sidewall sealed to the shaped paperboard bottom blank.

35. A cylindrical punch head for shaping a paperboard bottom blank to shape a peripheral skirt portion about a periphery of the paperboard bottom blank, the cylindrical punch head comprising:
a punch face extending in a radial direction about an axis of the punch head; and
a punch sidewall extending in an axial direction of the punch head about a periphery of the punch face; and
a beveled border of the punch face and the punch sidewall.

36-65. (canceled)

66. A cylindrical punch head for shaping a paperboard bottom blank to shape a peripheral skirt portion about a periphery of the paperboard bottom blank, the cylindrical punch head comprising:
a punch face extending in a radial direction about an axis of the punch head;
a punch sidewall extending in an axial direction of the punch head about a periphery of the punch face; and
a border of the punch face and the punch sidewall, the border comprising a plurality of edges extending around the punch face.

67-99. (canceled)
